(19) United States
(12) Patent Application Publication
(10) Pub. No.: US 2025/0051119 A1
(43) Pub. Date: Feb. 13, 2025

(54) SHEET CONVEYING DEVICE AND IMAGE FORMING APPARATUS

(71) Applicant: CANON KABUSHIKI KAISHA, Tokyo (JP)

(72) Inventor: TAKUYA KAWASUMI, Chiba (JP)

(21) Appl. No.: 18/750,130

(22) Filed: Jun. 21, 2024

(30) Foreign Application Priority Data
Aug. 10, 2023 (JP) 2023-131592

(51) Int. Cl. B65H 9/00; B65H 9/20

(52) U.S. Cl. CPC B65H 9/002; B65H 9/20; B65H 2301/331; B65H 2301/3613; B65H 2553/42

(57) ABSTRACT

A sheet conveying device includes a correcting portion and a side end detecting portion for detecting a side end of a sheet. The correcting portion includes a first roller whirlable about a first axis in a crossing direction crossing a conveyance direction and a widthwise direction and for correcting a position of the sheet in the widthwise direction, and a second roller disposed at a position different from the first roller in the widthwise direction, whirlable about a second axis in the crossing direction and for correcting the position of the sheet. Based on a detection result of the side end detecting portion, a control portion executes a first control in which the correcting portion corrects the position of the sheet in the widthwise direction and executes a second correcting control in which the correcting portion corrects the position of the sheet after the first correcting control.

### FIELD OF THE INVENTION AND RELATED ART

The present invention relates to a sheet conveying device and an image forming apparatus which corrects oblique movement and a position of a conveyed sheet in a widthwise direction.

In an image forming apparatus which forms an image on a sheet, oblique movement correction is performed to correct the oblique movement of the sheet conveyed to an image forming portion in order to form an image without a tilt with respect to the sheet.

In addition to the tilt of the conveyed sheet, lateral registration correction which corrects a position of the sheet in a widthwise direction is performed.

And particularly in an image forming apparatus which requires high accuracy printing, those which perform the oblique movement correction and the lateral registration correction of the sheet in two stages of rough adjustment and fine adjustment are proposed, as disclosed in Japanese Patent Application Laid-Open No. 2022-65880.

However, in Japanese Patent Application Laid-Open No. 2022-65880, a correcting roller is whirled about approximately a center of the sheet in the widthwise direction upon performing the oblique movement correction and the lateral registration correction. In this configuration, an end portion of the correcting roller in the widthwise direction is whirled widely, which may cause an increase in a size of an apparatus.

### SUMMARY OF THE INVENTION

A purpose of the present invention is to enable downsizing of a sheet conveying device provided with a whirlable roller.

According to an aspect of the present invention, there is provided a sheet conveying device comprising: a correcting portion provided with a first correcting roller whirlable about a first axis in a crossing direction crossing a conveyance direction of a sheet and a widthwise direction perpendicular to the conveyance direction, and configured to correct a position of the sheet in the widthwise direction, and a second correcting roller disposed at a position different from the first correcting roller in the widthwise direction, whirlable about a second axis in the crossing direction, and configured to correct the position of the sheet in the widthwise direction; a driving portion configured to whirlably drive the first correcting roller and the second correcting roller; a side end detecting portion configured to detect a side end of the sheet in the widthwise direction of the sheet; and a control portion configured to control the driving portion, wherein based on a detection result of the side end detecting portion, the control portion executes a first correcting control in which the correcting portion corrects the position of the sheet in the widthwise direction and executes a second correcting control in which the correcting portion corrects the position of the sheet in the widthwise direction after the first correcting control.

Further features of the present invention will become apparent from the following description of exemplary embodiments with reference to the attached drawings.

### BRIEF DESCRIPTION OF THE DRAWINGS

FIG. 1 is a schematic view illustrating an overall configuration of an inkjet recording system according to an Embodiment 1.

FIG. 2 is a top view illustrating a registration unit of a printing module according to the Embodiment 1.

FIG. 3 is a perspective view illustrating the registration unit of the printing module according to the Embodiment 1.

FIG. 4A is a perspective view illustrating the registration unit before a registration driving roller is whirled.

FIG. 4B is a perspective view illustrating the registration unit after the registration driving roller is whirled.

FIG. 5A is a top view of the registration unit before a sheet is conveyed.

FIG. 5B is a top view illustrating the registration unit in a state performing oblique movement correction of the sheet.

FIG. 5C is a top view illustrating the registration unit in a state performing lateral registration correction.

FIG. 6 is a side cross-sectional view illustrating the registration unit of the printing module according to the Embodiment 1.

FIG. 7A is a schematic view illustrating an example of measurement of an amount of the oblique movement.

FIG. 7B is a view illustrating an example of an oblique movement correction profile.

FIG. 7C is a schematic view illustrating an oblique movement correcting operation.

FIG. 8A is a schematic view illustrating an example of measurement of an amount of lateral registration misalignment.

FIG. 8B is a view illustrating examples of a lateral registration misalignment correction profile.

FIG. 8C is a schematic view illustrating a lateral registration misalignment correcting operation.

FIG. 9 is a flow chart illustrating control of the printing module according to the Embodiment 1.

FIG. 10 is a block diagram illustrating a configuration of a control system according to the Embodiment 1.

FIG. 11A is a top view illustrating disposition of image sensors, first leading registration sensors and second leading registration sensors according to the Embodiment 1.

FIG. 11B is a top view illustrating disposition of the image sensor, the first leading registration sensors and the second leading registration sensors in a case in which only one image sensor is used.

FIG. 11C is a top view illustrating disposition of the image sensor, the first leading registration sensors and the second leading registration sensors in a case in which the image sensor is configured to be a single image sensor.

FIG. 11D is a top view illustrating disposition of the image sensor in a case in which the oblique movement and a position of the sheet in a widthwise direction is detected by the single image sensor.

FIG. 12 is a view illustrating an example of correction profiles upon performing the lateral registration misalignment correction.

FIG. 13 is a view describing conversion of a speed component and an angle component of the registration driving roller in a case in which the oblique movement correction and the lateral registration misalignment correction are performed simultaneously.

FIG. 14 is a view illustrating an example of correction profiles when the oblique movement correction and the lateral registration misalignment correction are performed simultaneously.

FIG. 15 is a flow chart illustrating control of the printing module according to an Embodiment 2.

### DESCRIPTION OF THE EMBODIMENTS

### Embodiment 1

Hereinafter, Embodiments for carrying out the present invention will be described with reference to the drawings. In an Embodiment 1, a case in which an inkjet recording system 1 is employed as an image forming system will be described.

### [Inkjet Recording System]

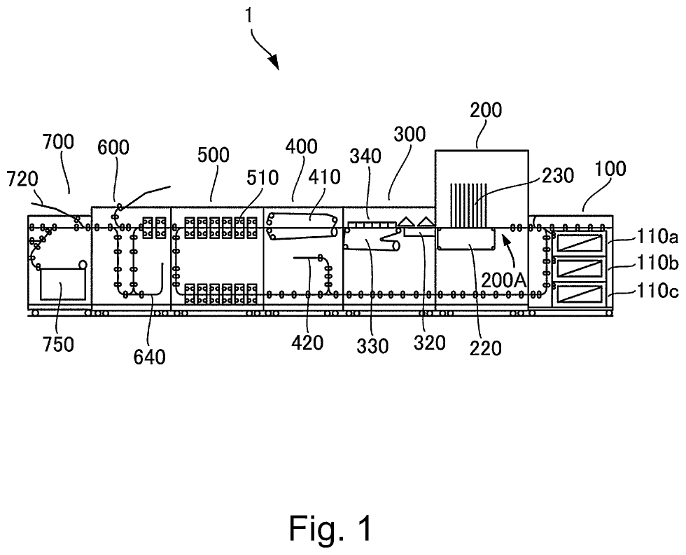

First, an overall configuration of the inkjet recording system 1 according to the Embodiment 1 will be described using FIG. 1. FIG. 1 is a schematic view illustrating the overall configuration of the inkjet recording system 1 according to the Embodiment 1. The inkjet recording system 1 as the image forming system is an inkjet recording system of a sheet-feeding type which produces a record in which an ink image is formed on a sheet S using two liquids of reaction fluid and ink. As shown in FIG. 1, the inkjet recording system 1 is constituted by a feeding module 100, a printing module 200, a drying module 300, a fixing module 400, a cooling module 500, a reversing module 600 and a discharging module 700. The sheet S in a cut paper shape supplied from the feeding module 100 is conveyed along a conveyance path, processed by each module, and discharged by the discharging module 700 as a sheet stacking device. In addition, in the inkjet recording system 1, an image is formed on the sheet in the printing module 200 as an image forming apparatus, and various types of processing are performed on the sheet on which the image is formed downstream of the printing module 200 in a conveyance direction of the sheet. Thus, the drying module 300, the fixing module 400, the cooling module 500, the reversing module 600 and the discharging module 700, etc. can also be referred to as processing devices.

The feeding module 100 is provided with three storages 110a, 110b and 110c which accommodates the sheet S. Each of the storages 110a, 110b and 110c is configured to be drawable toward a front side of the device. The sheet S is fed one by one by a separating belt and a conveyance roller in each of the storages 110a, 110b and 110c, and are conveyed to the printing module 200. Incidentally, a number of the storages 110a, 110b and 110c is not limited to three, but the system may be configured to include one or two, or four or more storages.

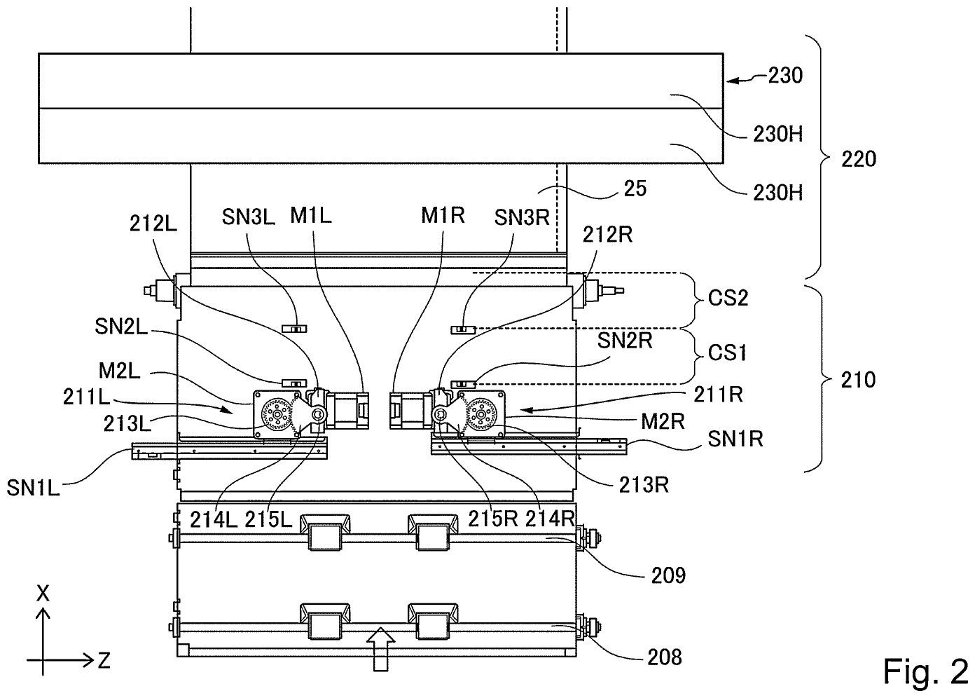

The printing module 200 is provided with a registration unit 210 (see FIG. 2), a printing belt unit 220, and a recording portion 230 as an oblique movement correcting portion which performs oblique movement correction and lateral registration correction before the image formation, as described in detail below. The sheet S conveyed from the feeding module 100 is conveyed to the printing belt unit 220 after a tilt and a position of the sheet are corrected by a plurality of conveyance roller pairs 208, 209 (see FIG. 2) as a conveyance portion and the registration unit 210. The recording portion 230 is disposed in a position opposite to the printing belt unit 220 with respect to the conveyance path. These conveyance roller pairs 208, 209 and the registration unit 210 constitute a sheet conveying portion 200A as a sheet conveying device which conveys the sheet to the recording portion 230. In addition, the recording portion 230 constitutes an image forming portion which forms the image by performing a recording process (printing) on the sheet S by a plurality of recording heads 230H from above on the conveyed sheet S (see FIG. 2).

The plurality of the recording heads 230H are arranged along the conveyance direction of the sheet (hereinafter simply referred to as “conveyance direction”). In the present Embodiment, a total of five recording heads of line type corresponding to four colors of Y (yellow), M (magenta), C (cyan) and Bk (black), as well as reaction fluid are provided. Incidentally, a number of colors and recording heads is not limited to five. As an inkjet method, a method using a heat-generating element, a method using a piezoelectric element, a method using an electrostatic element, a method using a MEMS element, etc. can be employed. The ink of each color is supplied from an ink tank to the recording head via an ink tube. The sheet S printed in the recording portion 230 is conveyed while ensuring clearance with the recording heads by being suctioned and conveyed by the printing belt unit 220. With respect to the sheet S printed in the recording portion 230, misalignment and color density of the image formed on the sheet S is detected by an in-line scanner disposed downstream of the recording portion in the conveyance direction. The detection result is used for correction of the printed image.

The drying module 300 is provided with a decoupling portion 320, a drying belt unit 330 and a hot air blowing portion 340, reduces a liquid content contained in the ink applied on the sheet in the recording portion 230 of the printing module 200, and enhances fixing performance of the ink to the sheet S. The sheet S printed in the recording portion 230 of the printing module 200 are conveyed to the decoupling portion 320, which is disposed on an upstream side of the drying module 300 in the conveyance direction. The decoupling portion 320 can convey the sheet S with wind pressure from above and friction of a belt, and prevents misalignment of the sheet S on the printing belt unit 220, which forms the ink image, by weakly holding and conveying the sheet S on the belt. The drying belt unit 330 is disposed below the belt and the hot air blowing portion 340 is disposed above the belt, opposing each other across the belt. The sheet S conveyed from the decoupling portion 320 is suctioned and conveyed by the drying belt unit 330, and at the same time, a surface on which the ink is applied is dried by receiving hot air from the hot air blowing portion 340. Incidentally, with regard to a drying type, in addition to a type applying the hot air, it may be configured by combining a type irradiating electromagnetic waves (such as ultraviolet or infrared rays) onto the surface of the sheet S and a conduction heat transfer type by a contact of a heat generating element.

The fixing module 400 is provided with a fixing belt unit 410. The fixing belt unit 410 is provided with an upper belt unit and a lower belt unit, and fixes the ink to the sheet S by passing the sheet S conveyed from the drying module 300 between the heated upper belt unit and the lower belt unit.

The cooling module 500 is provided with a plurality of cooling portions 510, and cools the hot sheet S conveyed from the fixing module 400. The cooling portion 510 is configured to cool the sheet S by sucking outside air into a cooling box with a fan, increasing pressure in the cooling box, and blowing air blown from a nozzle formed on a conveyance guide to the sheet S. The cooling portion 510 is disposed on both an upside and a downside with respect to the conveyance path and cools the sheet S from both sides.

In addition, the cooling module 500 is also provided with a conveyance path switching portion, which can switch the conveyance path of the sheet S depending on a case in which the sheet S is conveyed to the reversing module 600 or a case in which the sheet S is conveyed to a double-side conveyance path, which is used upon a double-side printing. During the double-side printing, the sheet S is conveyed to a conveyance path in a lower portion of the cooling module 500. In this case, the sheet S is further conveyed along the double-side conveyance path from the cooling module 500 through the fixing module 400, the drying module 300, the printing module 200 and the feeding module 100. In the double-side conveyance path of the fixing module 400, a first reversing portion 420 is provided to reverse a front and back of the sheet S. The sheet S is then conveyed again from the feeding module 100 through the pre image forming registration correcting portion of the printing module 200, the printing belt unit 220 and the recording portion 230, and the printing is performed in the recording portion 230.

The reversing module 600 is provided with a second reversing portion 640, and can reverse the front and back of the conveyed sheet and change front and back orientation of the discharged sheet. The discharging module 700 is provided with a top tray 720 and a stacking portion 750, and regulates and stacks the sheets S conveyed from the reversing module 600 on the top tray 720 or the stacking portion 750, or discharges the sheet S to an external tray, etc.

### [Registration Unit of the Printing Module and Surrounding Configuration Thereof]

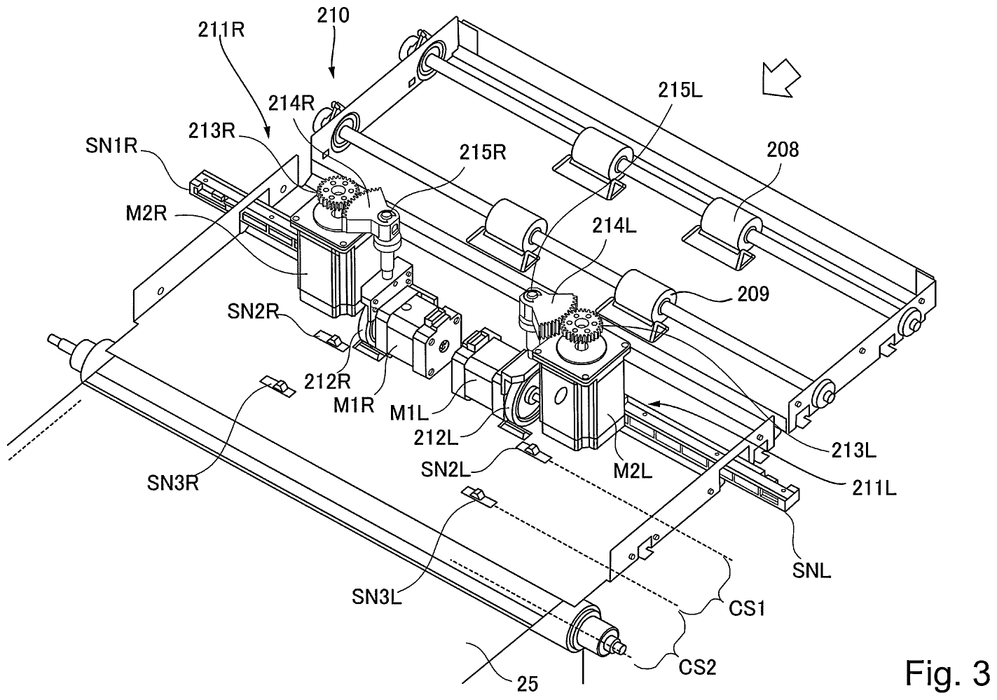

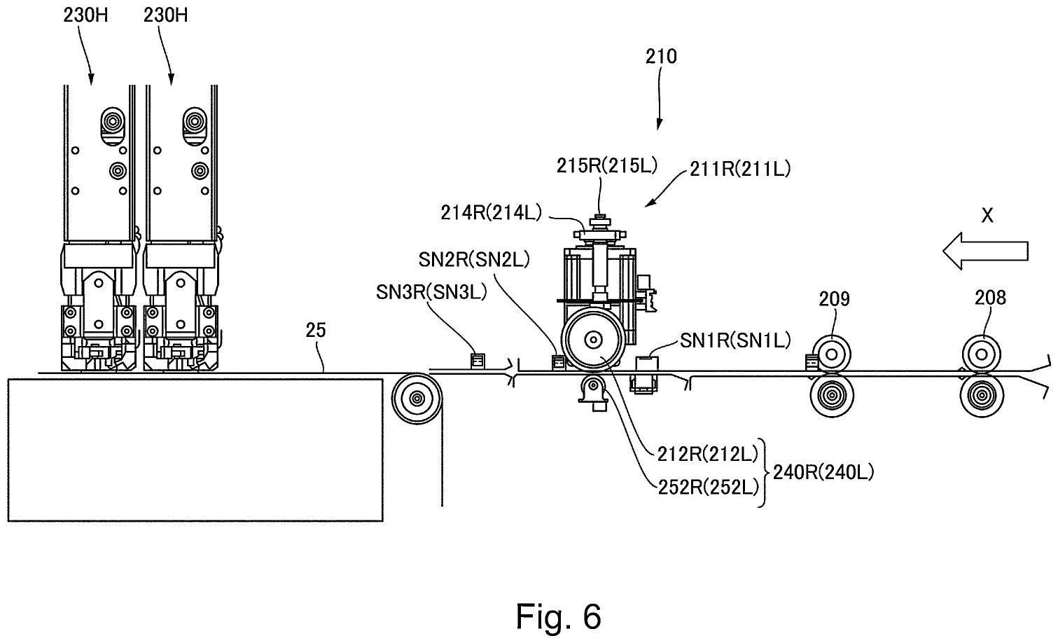

Next, the registration unit 210 in the printing module 200 and surrounding configuration thereof will be described using FIG. 2, FIG. 3 and FIG. 6. FIG. 2 is a top view illustrating the registration unit of the printing module according to the Embodiment 1. FIG. 3 is a perspective view illustrating the registration unit of the printing module according to the Embodiment 1. FIG. 6 is a side cross-sectional view illustrating the registration unit of the printing module according to the Embodiment 1.

In the printing module 200, as shown in FIG. 2 and FIG. 3, in the sheet conveying portion 200A (see FIG. 1), conveyance roller pairs 208, 209 are disposed in this order in a conveyance direction X. Incidentally, these conveyance roller pairs 208, 209 are provided with lower rollers which include rollers made of EPDM, for example, and upper rollers which include rubber rollers made of urethane, for example, and the lower roller is urged against the upper roller by a spring. Incidentally, the conveyance direction X referred here indicates a direction in a case in which the sheet S does not show the oblique movement, and does not refer to a conveyance direction in a steering operation described below.

In addition, in the sheet conveying portion 200A of the printing module 200, the registration unit 210 as a correcting portion is disposed downstream of the conveyance roller pairs 208, 209 in the conveyance direction X. That is, the registration unit 210 corrects posture of the sheet conveyed by the conveyance roller pairs 208, 209. Furthermore, in the printing module 200, the printing belt unit 220 is disposed downstream of the registration unit 210 in the conveyance direction X. The printing belt unit 220 is constituted by a printing belt 25 which is turned around so as to suction and convey the sheet, and the recording portion 230 (the plurality of recording heads 230H) (see FIG. 2) which forms the image on the sheet conveyed by the printing belt 25.

### [Registration Roller Pair]

As shown in FIG. 6, the registration unit 210 is provided with a left registration roller pair (hereinafter simply referred to as a “registration roller pair”) 240L on a left side from a conveyance center as facing along the conveyance direction X of the sheet (see FIG. 2). In addition, the registration unit 210 is also provided with a right registration roller pair (hereinafter simply referred to as the “registration roller pair”) 240R on a right side from the conveyance center as facing along the conveyance direction X (see FIG. 2) in a manner of being parallel to the left registration roller pair 240L. The registration roller pair 240L is constituted by a registration driving roller 212L as a first oblique movement correcting roller and a registration driven roller 252L, which is disposed opposite to the registration driving roller 212L and driven upon being in contact with the registration driving roller 212L. Furthermore, the registration roller pair 240R is similarly constituted by a registration driving roller 212R as a second oblique movement correcting roller and a registration driven roller 252R, which is disposed opposite to the registration driving roller 212R and driven upon being in contact with the registration driving roller 212R. Incidentally, the registration driving rollers 212L, 212R are constituted by rubber rollers made of polyurethane, for example, and the registration driven rollers 252L, 252R are constituted by rollers made of EPDM, for example. Incidentally, the registration driven rollers 252L, 252R of these registration roller pairs 240L, 240R are configured to be movable between a contact position in which the registration driven rollers 252L, 252R are in contact with the registration driving rollers 212L, 212R and a separated position in which the registration driven rollers 252L, 252R are separated from the registration driving rollers 212L, 212R by a separating mechanism 270.

### [Driving and Whirling Mechanism]

Next, driving and whirling mechanisms 211L, 211R in the registration unit 210 will be described. As shown in FIG. 2 and FIG. 3, the registration unit 210 is provided with the driving and whirling mechanisms 211L, 211R which rotationally drives and whirls the registration driving rollers 212L, 212R, respectively. Each of the driving and whirling mechanisms 211L, 211R includes a registration driving motor M1L as a first rotatably driving motor and a registration driving motor M1R as a second rotatably driving motor. In addition, each of the driving and whirling mechanisms 211L, 211R includes a steering motor M2L as a first whirlably driving motor and a steering motor M2R as a second whirlably driving motor. Furthermore, each of the driving and whirling mechanisms 211L, 211R includes motor gears 213L, 213R, drive input gears 214L, 214R, and steering shafts 215L, 215R, which transmit rotation of the steering motors M2L, M2R.

Rotation shafts of each of the registration driving motors M1L, M1R are drivably connected to the registration driving rollers 212L, 212R. In other words, the registration driving rollers 212L, 212R are rotationally driven so that rotation speed thereof can be changed independently by rotation of the registration driving motors M1L, M1R.

Each of the steering shafts 215L, 215R rotatably supports frames 216L, 216R (see FIG. 3), which support the registration driving rollers 212L, 212R and the registration driving motors M1L, M1R, respectively. That is, the registration driving rollers 212L, 212R and the registration driving motors M1L, M1R are rotatably (whirlably) supported about the steering shafts 215L, 215R, whose axial direction is a crossing direction which crosses (is perpendicular to) the conveyance direction X and a widthwise direction W, which is perpendicular to the conveyance direction X, respectively.

On the other hand, each of the steering motors M2L, M2R is disposed along an axial direction parallel to an axial direction of the steering shafts 215L, 215R, and the motor gears 213L, 213R are fixed to each of the rotation shafts. With each of these motor gears 213L, 213R, the drive input gears 214L, 214R fixed to each of the steering shafts 215L, 215R are meshed. By this, it becomes possible to whirl (rotate) the registration driving rollers 212L, 212R and the registration driving motors M1L, M1R about the steering shafts 215L, 215R by controlling the rotation of the steering motors M2L, M2R.

In short, the registration driving rollers 212L, 212R are configured to be rotationally driven by the registration driving motors M1L, M1R and whirled by the steering motors M2L, M2R to a direction tilted with respect to the conveyance direction X. By this it becomes possible for the registration roller pairs 240L, 240R to change conveying speeds independently, respectively, and also change the conveyance directions independently, respectively.

Incidentally, home position sensors are disposed in the vicinity of each of the registration driving rollers 212L, 212R, and home positions of the registration driving rollers 212L, 212R are detected by the home position sensors. The home positions of the registration driving rollers 212L, 212R are, in other words, positions in which the registration roller pairs 240L, 240R face straight (without tilt) in the conveyance direction X. In other words, it is configured that the registration roller pairs 240L, 240R can be positioned back to the positions in which the registration roller pairs 240L, 240R are not tilted with respect to the conveyance direction.

### [Configuration of Detection of the Oblique Movement of the Sheet]

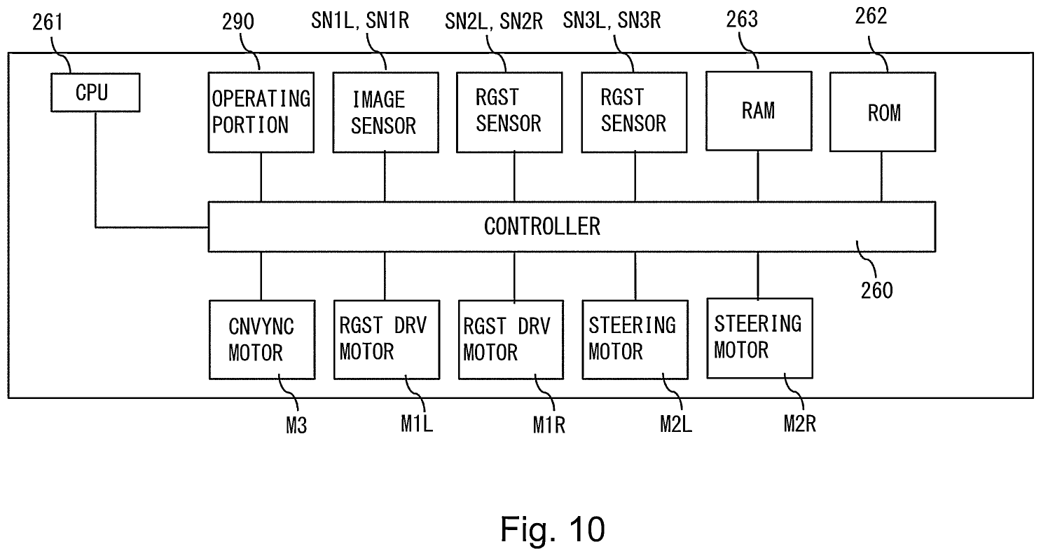

In the vicinity of each nip of the registration roller pairs 240L, 240R, in the same position in the conveyance direction X (that is, so as to align in the widthwise direction W), leading registration sensors SN2L, SN2R as detecting portions or first amount of oblique movement detecting portions, which are constituted by, for example, optical sensors, etc., are disposed. That is, these leading registration sensors SN2L, SN2R are disposed immediately downstream of the registration roller pairs 240L, 240R in the conveyance direction X. A controller 260 as a control portion described below (see FIG. 10) calculates an amount of the oblique movement of the sheet S based on difference in timing when each of the leading registration sensors SN2L, SN2R detects the leading end of the sheet S, and the conveying speed at which the sheet S is conveyed.

In addition, similarly, downstream of the leading registration sensors SN2L, SN2R, the leading registration sensors SN3L, SN3R as detecting portions or second amount of oblique movement detection portions, which are constituted by, for example, optical sensors, etc., are disposed. Similarly, the controller 260 (see FIG. 10) calculates the amount of the oblique movement of the sheet S based on the difference in timing when the leading registration sensors SN3L, SN3R detects the leading end of the sheet S and the conveying speed at which the sheet S is conveyed. That is, the leading registration sensors SN3L, SN3R detect the amount of the oblique movement of the sheet in a second position conveyed downstream in the conveyance direction X from a first position of the sheet at which the leading registration sensors SN2L, SN2R detect the amount of the oblique movement. Incidentally, a section in which the leading of the sheet reaches from the leading registration sensors SN2L, SN2R to the leading registration sensors SN3L, SN3R is defined as a first correcting section CS1, in which a first correcting control, which will be described in detail below, is performed. In addition, a section in which the leading end of the sheet reaches from the leading registration sensors SN3L, SN3R to the printing belt 25 is defined as a second correcting section CS2, in which a second correcting control, which will be described in detail below, is performed.

### [Configuration of Detection of a Position of the Sheet in the Widthwise Direction]

Upstream of each of the registration roller pairs 240L, 240R in the conveyance direction X, image sensors SN1L, SN1R as detecting portions or widthwise position detecting portions are disposed. The image sensor SN1L detects an edge position of a left end portion of the sheet S, and the image sensor SN1R detects an edge position of a right end portion of the sheet S. For these image sensors SN1L, SN1R, for example, optical sensors such as CIS sensors can be used. And these image sensors SN1L, SN1R detect a position of the sheet S in the widthwise direction based on the edge positions of the left end portion and the right end portion of the sheet, and the controller 260 (see FIG. 10) calculates a misaligned amount of the position in the widthwise direction (so-called lateral registration misaligned position) based on this detection result.

Incidentally, when the leading end of the sheet of the minimum size conveyable by the printing module 200 reaches the leading registration sensors SN3L, SN3R, these image sensors SN1L, SN1R are disposed in a position so as to be capable of detecting the position of the sheet in the widthwise direction. In other words, it is configured that the misaligned amount of the position in the widthwise direction can be detected both when the amount of the oblique movement is detected when the sheet is in the first position and when the amount of the oblique movement is detected when the sheet is in the second position. By this, it becomes possible to detect the amount of the oblique movement and the position in the widthwise direction of the sheet at the first position and the amount of the oblique movement and the position in the widthwise direction of the sheet at the second position in a case in which any size of the sheet is conveyed.

### [Modified Examples of the Detection of the Oblique Movement and the Position in the Widthwise Direction of the Sheet]

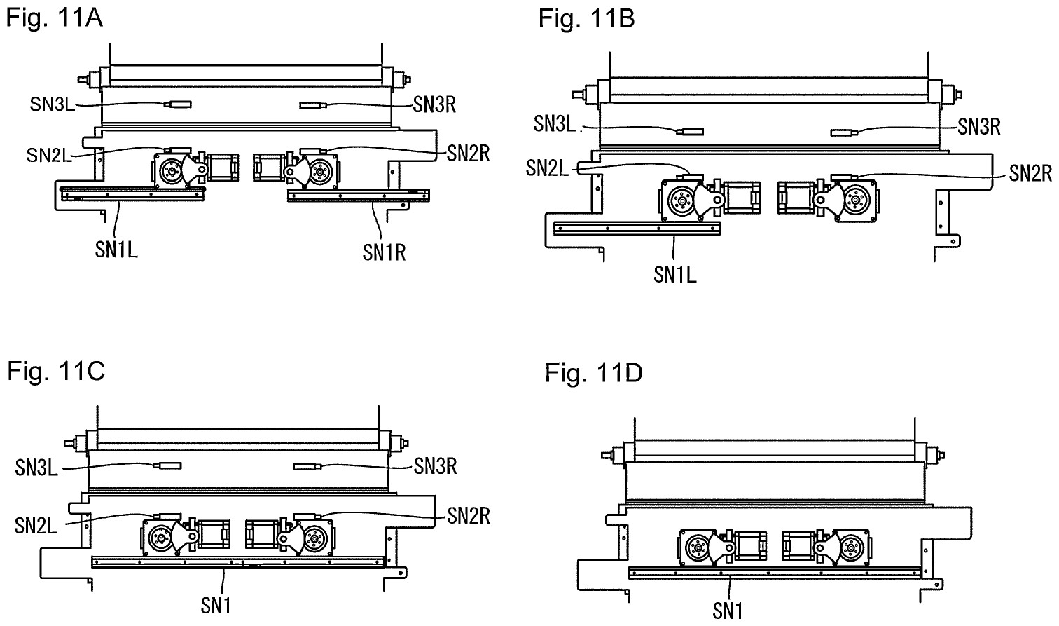

Here, Modified Examples of the configuration for detecting the oblique movement of the sheet and the configuration for detecting the position of the sheet in the widthwise direction will be described using FIG. 11A, FIG. 11B, FIG. 11C and FIG. 11D. FIG. 11A is a top view illustrating disposition of the image sensors, the first leading registration sensors and the second leading registration sensors according to the Embodiment 1. FIG. 11B is a top view illustrating disposition of the image sensor, the first leading registration sensors and the second leading registration sensors in a case in which only one image sensor is used. FIG. 11C is a top view illustrating disposition of the image sensor, the first leading registration sensors and the second leading registration sensors in a case in which the image sensor is configured to be a single image sensor. FIG. 11D is a top view illustrating disposition of the image sensor in a case in which the oblique movement and the position of the sheet in the widthwise direction is detected by the single image sensor

As shown in FIG. 11A, in the Embodiment 1, the leading registration sensors SN2L, SN2R are disposed downstream of the registration roller pairs 240L, 240R in the conveyance direction X. In addition, the leading registration sensors SN3L, SN3R are disposed downstream of the leading registration sensors SN2L, SN2R in the conveyance direction X. Furthermore, the image sensors SN1L, SN1R are disposed upstream of the registration roller pairs 240L, 240R in the conveyance direction X.

In contrast, what shown in FIG. 11B as a Modified Example is a configuration in which only image sensor SN1L is disposed and an image sensor SN1R is eliminated. That is, when the controller 260 (see FIG. 10) recognizes the size of the sheet, the position of the sheet in the widthwise direction can be calculated if the edge position of the left end portion of the sheet can be detected by the one image sensor SN1L only. Incidentally, it may be configured that the image sensor SN1R detects the edge position of the right end portion of the sheet and calculates the position of the sheet in the widthwise direction.

In addition, what shown in FIG. 11C as a Modified Example is a configuration in which an image sensor SN1 is disposed over an entire conveyance area, in which the sheet can be conveyed, in the widthwise direction, in other words, is provided with the image sensor SN1, which is longer in the widthwise direction than the image sensors SN1L, SN1R. This image sensor SN1 can scan both end portions of the sheet in the widthwise direction and can detect the edge positions of the left end portion and the right end portion of the sheet.

And what shown in FIG. 11D as a Modified Example is a configuration in which only the image sensor SN1 is provided and the leading registration sensors SN2L, SN2R and the leading registration sensors SN3L, SN3R are eliminated. Even in such a configuration, if the positions of both end portions of the sheet in the widthwise direction are continuously detected by the image sensor SN1, the position of the end portion and movement (oblique movement) of the sheet can be calculated. That is, by monitoring the positions of the end portions of the sheet detected by the image sensor SN1 for a certain period of time at a timing when the sheet is in the first position or the second position, the amount of the oblique movement of the sheet can be calculated, and at the same time, the position of the sheet in the widthwise direction can also be calculated.

Incidentally, Modified Examples are described using FIG. 11B, FIG. 11C and FIG. 11D, however, it is not limited thereto but any configuration or disposition of the sensor may be employed as long as the amount of the oblique movement and the position in the widthwise direction when the sheet is in the first position and the amount of the oblique movement and the position in the widthwise direction when the sheet is in the second position can be detected.

### [Configuration of the Control System of the Printing Module]

Next, a configuration of a control system in the printing module 200 will be described using FIG. 10. FIG. 10 is a block diagram illustrating the configuration of the control system according to the Embodiment 1.

As shown in FIG. 10, the controller 260, which functions as a control portion, is connected to a CPU 261, a ROM 262 and a RAM 263, and programs stored in the ROM 262, etc. are executed by the CPU 261 while using a storage area of the RAM 263. In addition, to the controller 260, an operating portion 290 such as an operating panel and an external computer are connected via an interface to receive various types of input or to display results.

Furthermore, to the controller 260, various types of sensors such as the image sensors SN1L, SN1R, the first leading registration sensors SN2L, SN2R, the second leading registration sensors SN3L, SN3R described above are connected. In addition, to the controller 260, various types of motors such as the registration driving motors M1L, M1R, the steering motors M2L, M2R, which are mentioned above, and a conveyance motor M3 which drives the conveyance roller pairs 208, 209 are connected. Based on detection results of these various types of sensors, while the controller 260 executes driving control of the various types of motors to convey the sheet, the controller 260 executes correcting control including both the oblique movement correction and the lateral registration misalignment correction as a width position correction, which will be described in detail later.

### [Oblique Movement Correcting Operation]

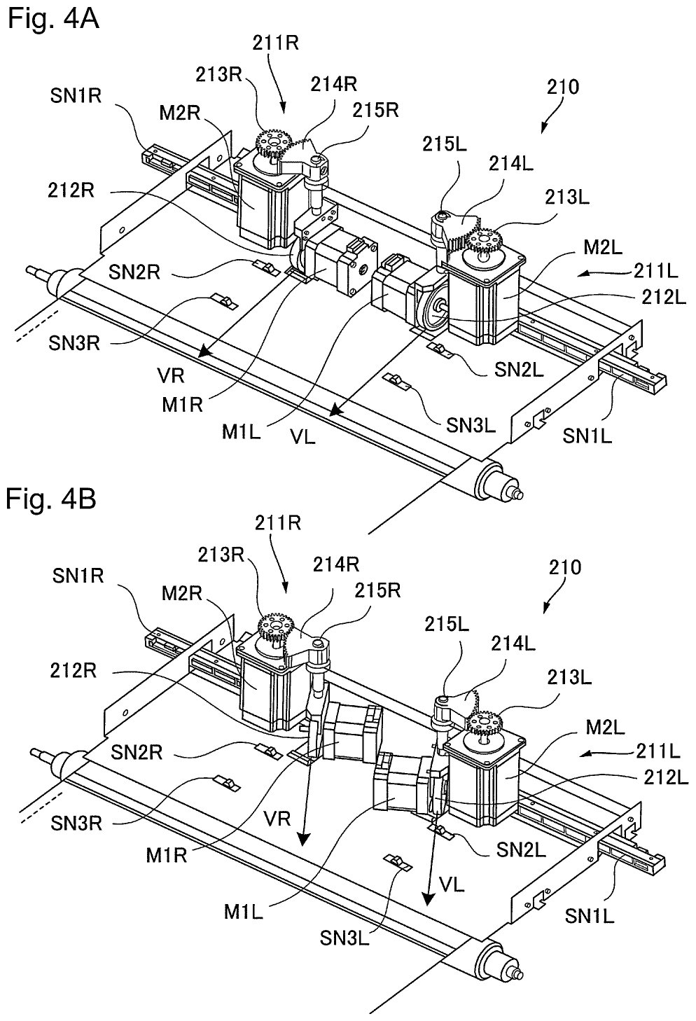

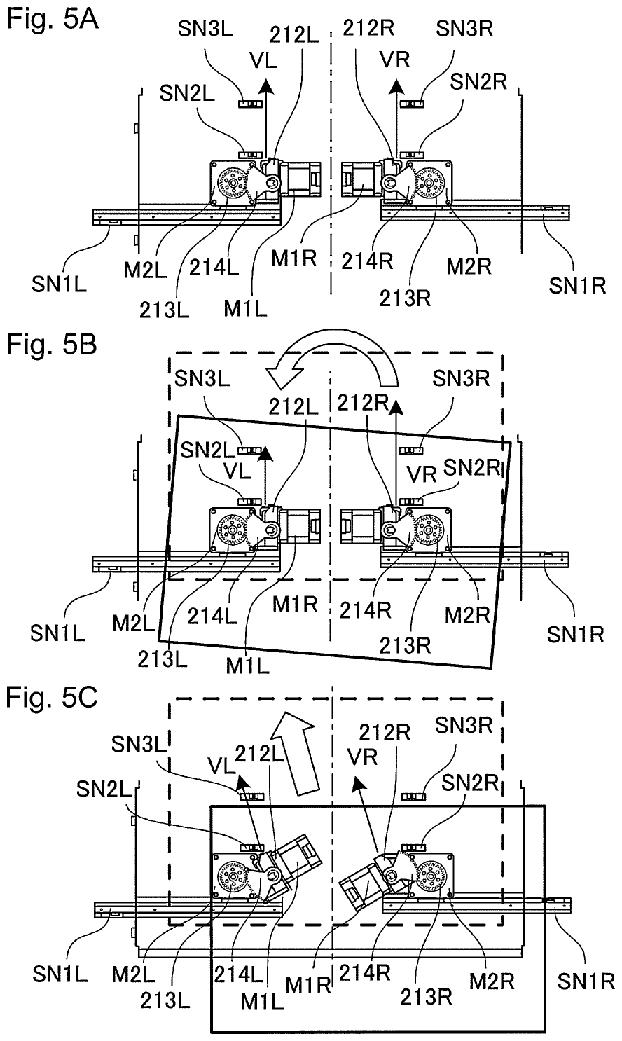

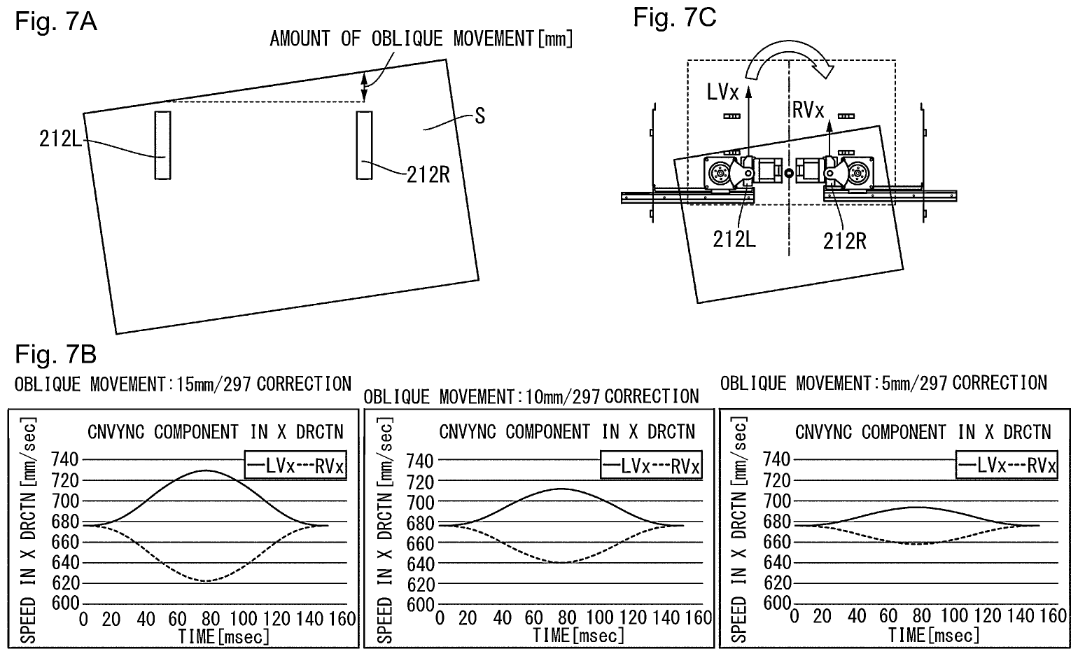

Next, a principle of the oblique movement correcting operation (active registration operation) will be described using FIG. 4A, FIG. 4B, FIG. 5A, FIG. 5B, FIG. 5C, FIG. 7A, FIG. 7B and FIG. 7C.

FIG. 4A is a perspective view illustrating the registration unit before the registration driving roller is whirled. FIG. 4B is a perspective view illustrating the registration unit after the registration driving roller is whirled. FIG. 5A is a top view illustrating the registration unit before the sheet is conveyed. FIG. 5B is a top view illustrating the registration unit in a state in which the oblique movement correction of the sheet is performed. FIG. 5C is a top view of the registration unit in a state in which the lateral registration correction of the sheet is performed. FIG. 7A is a schematic view illustrating an example of measurement of the amount of the oblique movement. FIG. 7B is a view illustrating an example of an oblique movement correction profile. FIG. 7C is a schematic view illustrating an oblique movement correcting operation. Incidentally, the oblique movement correction is what corrects an angle of a moving direction of the sheet so as to be parallel to the conveyance center, which is a center in the widthwise direction of the conveyance path which conveys the sheet.

In the registration unit 210, as described above, the registration driving rollers 212L, 212R are independently driven by the registration driving motors M1L, M1R, and it is configured that the rotation speeds can be changed independently. The controller 260 determines oblique movement correction profiles for correcting the oblique movement of the sheet based on a tilted angle of the sheet detected by the leading registration sensors SN2L, SN2R or the leading registration sensors SN3L, SN3R. This oblique movement correction profiles are control amounts for controlling difference in speeds between the registration driving rollers 212L, 212R. And the controller 260 drives the registration driving motors M1L, M1R based on the oblique movement correction profiles to rotate the registration driving rollers 212L, 212R.

Here, the oblique movement correction profile will be described. For example, as shown in FIG. 4A and FIG. 5B, when the oblique movement correction is not performed, the registration driving rollers 212L, 212R face the conveyance direction X and are rotated to convey the sheet at the same speeds VL, VR. Here, the sheet is conveyed and, as shown in FIG. 4B and FIG. 7A, for example, the amount of the oblique movement of the sheet is detected by the leading registration sensors SN2L, SN2R. The controller 260 then generates the oblique movement correction profiles as shown in FIG. 7B based on the detected amount of the oblique movement. This oblique movement correction profiles are generated as speed tables so that the amount of the oblique movement detected by the leading registration sensors SN2L, SN2R and difference between an integral value of a speed LVx of the registration driving roller 212L and an integral value of a speed RVx of the registration driving roller 212R are equal. That is, as shown in FIG. 7B, the oblique movement correction profiles are set by multiplying coefficients corresponding to the amount of the oblique movement. The controller 260 drives the registration driving motors M1L, M1R according to the oblique movement correction profiles thus generated. By this, the difference in speeds between the registration driving roller 212L (LVx), which is rotationally driven by the registration driving motor M1L, and the registration driving roller 212R (RVx), which is rotationally driven by the registration driving motor M1R, is generated as shown in FIG. 7C. As a result, the sheet conveyed by the registration driving rollers 212L, 212R rotate, and the oblique movement is corrected. Incidentally, in an example of the oblique movement correction profiles shown in FIG. 7B, an example using curvilinear driving is exemplified, however, triangular driving, trapezoidal driving, etc. may also be used.

### [Lateral Registration Misalignment Correcting Operation]

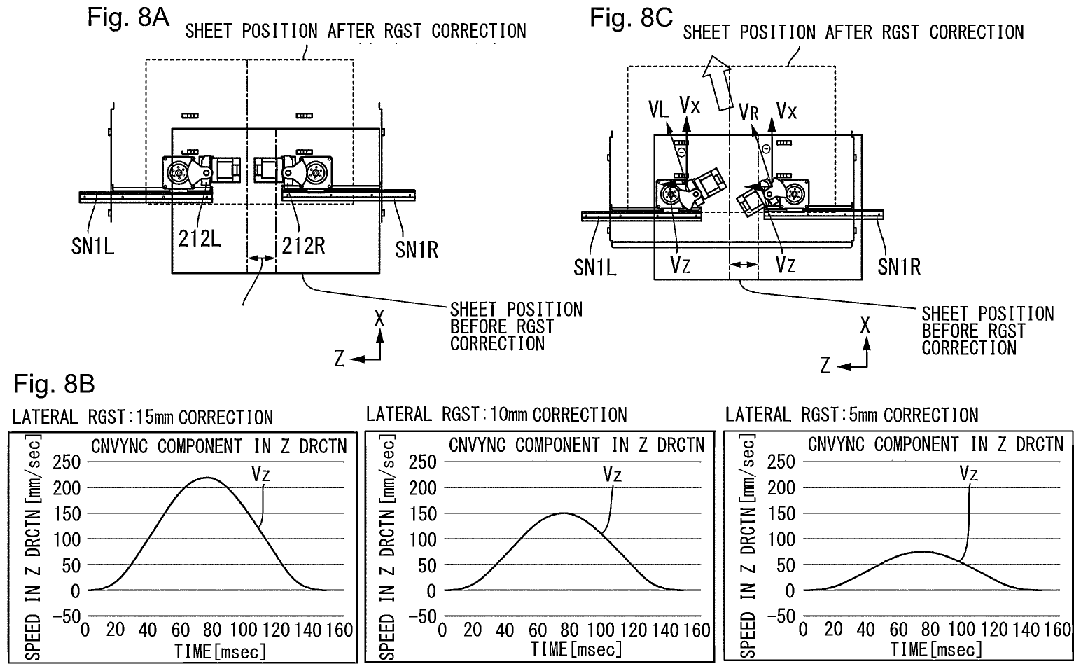

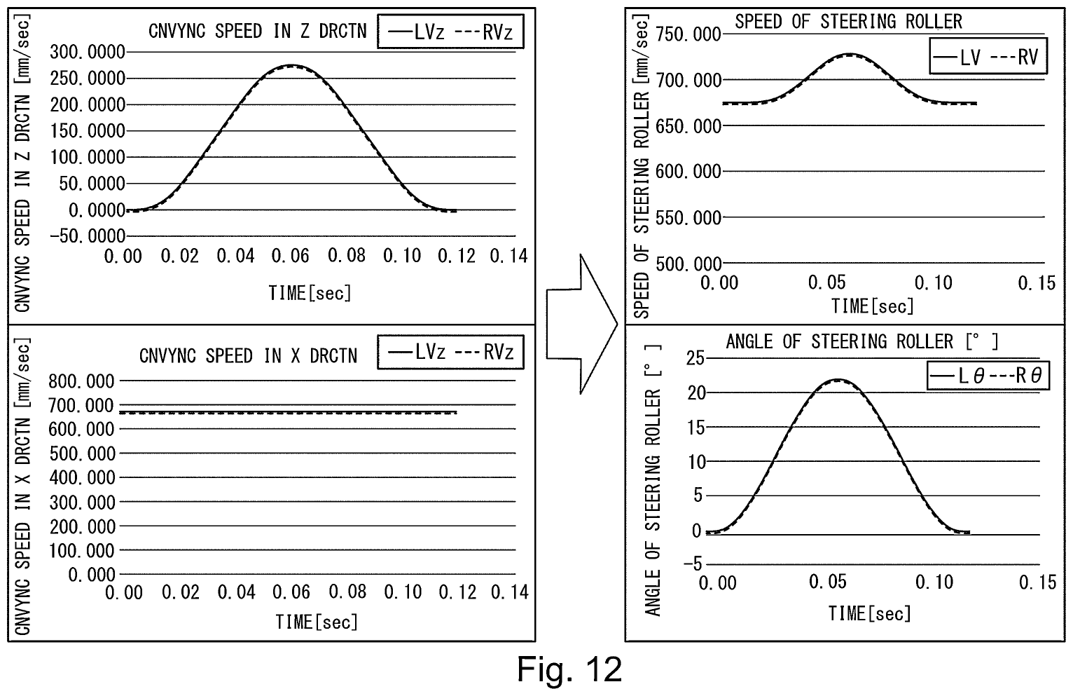

Next, a principle of the lateral registration misalignment correcting operation (steering operation) will be described using FIG. 8A, FIG. 8B, FIG. 8C and FIG. 12. FIG. 8A is a schematic view illustrating an example of measurement of an amount of lateral registration misalignment. FIG. 8B is a view illustrating examples of a lateral registration misalignment correction profile. FIG. 8C is a schematic view illustrating the lateral registration misalignment correcting operation. FIG. 12 is a view illustrating an example of the correction profiles upon performing the lateral registration misalignment correction.

Incidentally, a vertical direction in FIG. 8A corresponds to the conveyance direction X of the sheet, and a horizontal direction in FIG. 8 corresponds to a widthwise direction Z, which is perpendicular to the conveyance direction X. The lateral registration misalignment correction is what corrects the position of the sheet in the widthwise direction so as to be aligned in a position in the widthwise direction where the image is formed, and in most cases, what aligns a center of the sheet in the widthwise direction with the center of the conveyance path in the widthwise direction (reference position). In addition, it is not limited thereto in a case in which a position in the widthwise direction of the image formed on the sheet in the image forming portion (recording portion 230) is not aligned with the center of the conveyance path in the widthwise direction.

As described above, the conveyance direction of the registration driving rollers 212L, 212R can be changed about the steering shafts 215L, 215R via the drive input gears 214L, 214R by the steering motors M2L, M2R, respectively. For example, when the oblique movement correction of the sheets is not performed, it is operated so that the speeds VL, VR and the conveyance directions of the registration driving rollers 212L, 212R are the same. The controller 260 determines the profiles as the control amount for correcting the lateral registration misalignment based on the position of the end portions of the sheet detected by the image sensors SN1L, SN1R. That is, the controller 260 determines the profiles of the steering motors M2L, M2R, which change the conveyance directions of the registration driving rollers 212L, 212R.

Here, the profile for the lateral registration misalignment correction will be described. As shown in FIG. 8A, an amount of lateral misalignment, which is positional misalignment in the widthwise direction, is detected by the image sensors SN1L, SN1R. The controller 260 then generates a profile for the lateral registration misalignment correction (speed in a Z direction component) as shown in FIG. 8B based on the detected amount of the lateral misalignment. The profile for the lateral registration misalignment correction is generated as a speed table so that the detected amount of the lateral misalignment and an integral value of a speed of the roller Vz of a component in the widthwise direction Z in a correcting section, which is set in advance, are equal. That is, as shown in FIG. 8B, the lateral registration misalignment correction profile is set by multiplying a coefficient corresponding to the amount of the lateral registration misalignment.

In a case in which the lateral registration misalignment correction and the oblique movement correction are not performed simultaneously, it is preferable that a speed of the roller Vx as a component in the conveyance direction X, be the same as the conveying speed of the printing belt unit 220 disposed downstream of the conveyance direction X. By the speed of the roller Vx of the component in the conveyance direction X and the speed of the roller Vz of the component in the widthwise direction Z being determined, as shown in FIG. 8C, angles of the rollers θ and speeds of the rollers V can be calculated based on the velocity Vx and the velocity Vz using trigonometric functions. By calculating the angles θL, θR and the speeds VL, VR of the rollers per unit time, respectively, as shown in FIG. 12, operating profiles of the steering motors M2L, M2R and the registration driving motors M1L, M1R can be generated. According to the profiles, the steering motors M2L, M2R and the registration driving motors M1L, M1R are driven. By this, as shown in FIG. 4B, FIG. 5C and FIG. 8C, the registration driving roller 212L is whirled by the steering motor M2L and the registration driving roller 212R is whirled by the steering motor M2R. Therefore, the sheet is obliquely conveyed by the registration driving rollers 212L, 212R, and the lateral registration misalignment is corrected. Incidentally, in the example of the speed correction profile shown in FIG. 8B as well, an example using the curvilinear driving is exemplified, however, triangular driving, trapezoidal driving, etc. may also be used.

### [Simultaneous Correction of the Oblique Movement Correction and the Lateral Registration Misalignment Correction]

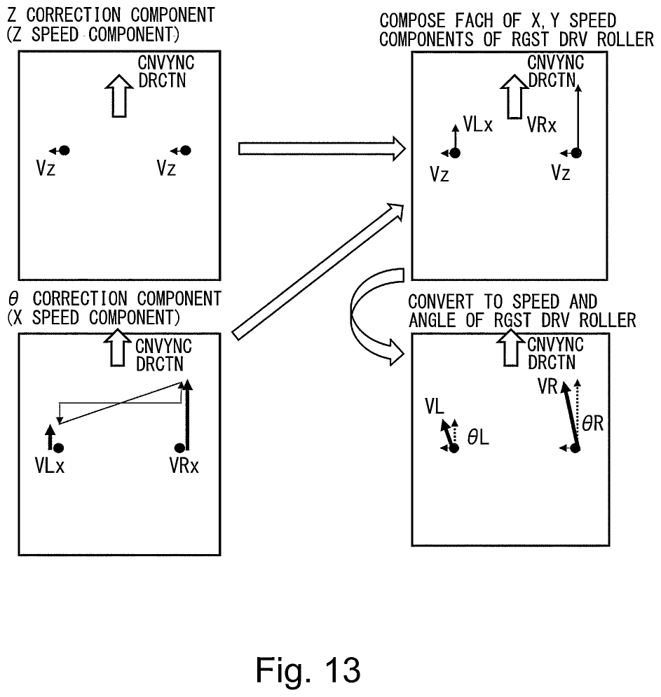

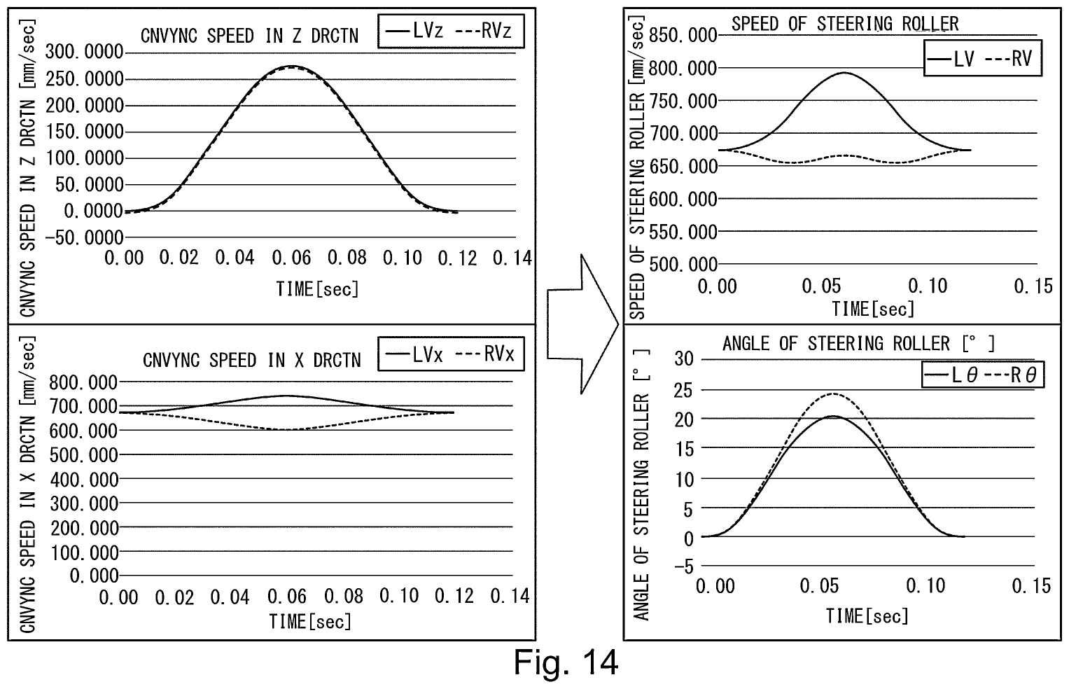

Next simultaneous correction of the oblique movement correction and the lateral registration misalignment correction will be described using FIG. 13 and FIG. 14. FIG. 13 is a view describing conversion between the velocity component and the angle component of the registration driving roller when the oblique movement correction and the lateral registration misalignment correction are performed simultaneously. FIG. 14 is a view illustrating an example of correction profiles when the oblique movement correction and the lateral registration misalignment correction are performed simultaneously.

As described above, the oblique movement of sheet is corrected by the difference in speeds of the registration driving motors M1L, M1R, and by this, the oblique movement correction can be performed. In addition, the lateral registration misalignment of the sheet is corrected by the registration driving rollers 212L, 212R being whirled by the steering motors M2L, M2R.

In these descriptions, the operation of the oblique movement correction and the operation of the lateral registration misalignment correction are described separately, however, these can be performed simultaneously. As shown in FIG. 13, by composing the component of the lateral registration misalignment in the widthwise direction Z (Z correction component) and the component of the amount of the oblique movement (angle of the oblique movement) (θ correction component), it is possible to convert these components into the speeds VL, VR and the angles (steering angles) of the respective registration driving rollers 212L, 212R. In short, as shown in FIG. 14, the speeds LVz, RVz of the registration driving rollers 212L, 212R in the profiles of the lateral registration misalignment correction and the speeds LVx, RVx of the registration driving rollers 212L, 212R in the profiles of the oblique movement correction are composed. Then, the angles of the rollers Lθ, Rθ and the speeds VL, VR per unit time are determined to generate profiles for the simultaneous correction which simultaneously performs the oblique movement correction and the lateral registration misalignment correction. Then, according to the generated profiles for the simultaneous correction, the registration driving motors M1L, M1R and the steering motors M2L, M2R are driven. By this, it becomes possible to perform the oblique movement correction and the lateral registration misalignment correction simultaneously.

### [Operation in the Printing Module]

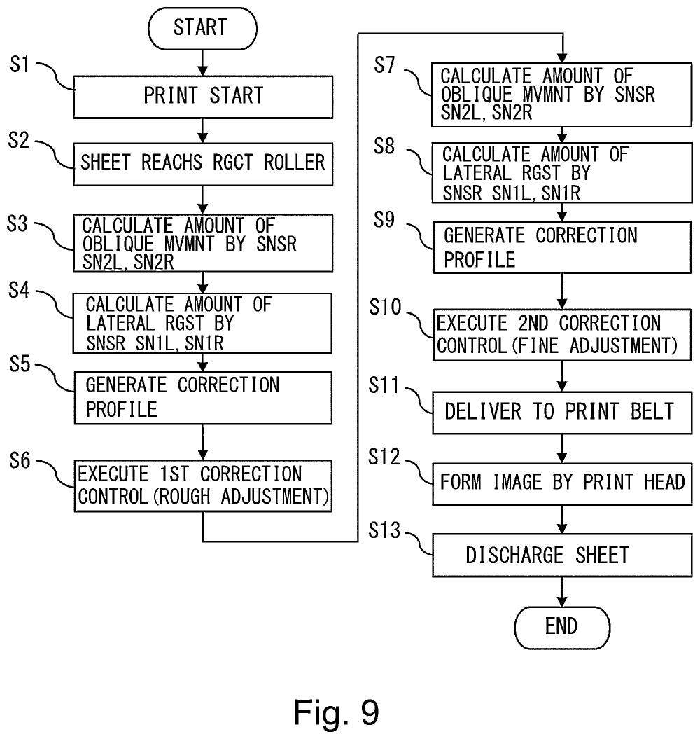

Next, operation of the printing module 200 will be described using FIG. 9. FIG. 9 is a flow chart illustrating control of the printing module according to the Embodiment 1. Incidentally, in control of an image formation shown in FIG. 9, an example in which the image is formed on one side of the sheet will be described, however, even in a case in which the images are formed on both sides of the sheet, the present control is performed repeatedly.

For example, if accuracy of the oblique movement correction and the lateral registration misalignment correction described above are not good, there is a possibility that the image formed on the sheet is tilted, misaligned or distorted. In addition, especially when the images are formed on both sides of the sheet, if the accuracy of the oblique movement correction and the lateral registration misalignment correction described above are not good, there is a possibility that the image on the front surface of the sheet and the image on the back surface of the sheet is significantly misaligned. In the present control, by performing the first correcting control and the second correcting control, which perform the oblique movement correction and the lateral registration misalignment correction as described in detail below, the accuracy of the oblique movement correction and the lateral registration misalignment correction is improved.

### (Print Start)

First, the controller 260 starts control for the image formation shown in FIG. 9 at a timing when the controller 260 receives a print job, either directly from the operating portion 290 or from the external computer connected to the controller via a network. The print job received by the controller 260 includes information such as a number of prints, a size of the sheet S to be printed, which are specified by a user. That is, the controller 260 determines the start of the printing according to the received print job (S1).

Next, the controller 260 selects the sheet S of the size specified in the print job, for example, from one of the storages 110a, 110b or 110c, and feeds the sheet S by the feeding module 100. Then, the controller 260 drives driving motors, etc. to convey the sheet S toward the registration unit 210 with the conveyance roller pairs 208, 209 (see FIG. 2), causing the sheet S to reach the registration roller pairs 240L, 240R (S2).

### (First Correcting Control)

Next, the controller 260 proceeds to a series of processes of steps S3 through S6 as the first correcting control, which is a first time correcting control. First, when the sheet S reaches the leading registration sensors SN2L, SN2R, the controller 260 calculates the amount of the oblique movement of the sheet S based on the detection results input from the leading registration sensors SN2L, SN2R (S3). That is, when the leading end of the sheet S reaches both the leading registration sensors SN2L, SN2R, detecting operation for the first correcting control is started. Incidentally, the amount of the oblique movement of the sheet S here is a tilted angle with respect to the conveyance direction X, or more precisely, a tilted angle with respect to the widthwise direction Z at the leading end of the sheet S. Specifically, as described above, the controller 260 determines the amount of the oblique movement of the sheet S based on difference in timings between when each of the two leading registration sensors SN2L, SN2R detects the leading end of the conveyed sheet S and the speed V (conveying speed) of the sheet S.

Next, the controller 260 calculates the position of the sheet S in the widthwise direction, in other words, a lateral misaligned position, based on the detection results input from the image sensors SN1L, SN1R (S4). That is, the controller 260 calculates the amount of the lateral misalignment between the conveyance center and the center of the sheet from both end portions of the sheet S in the widthwise direction Z, which is perpendicular to the conveyance direction X, by detecting how much of a part of the image sensors SN1L, SN1R are covered by the sheet S.

Next, the controller 260 generates the oblique movement correction profiles as the first control amount to correct the oblique movement of the sheet S based on the amount of the oblique movement of the sheet S determined as described above. In addition, the controller 260 also generates the profiles for the lateral registration misalignment correction as the first control amount to correct the lateral misalignment of the sheet S based on the amount of the lateral misalignment of the sheet S determined as described above. And then the controller 260 generates the correction profile composed of these oblique movement correction profiles and the profiles for the lateral registration misalignment correction (S5). That is, profile generating operation in the first correcting control is performed.

Next, the controller 260 controls the registration driving motors M1L, M1R and the steering motors M2L, M2R according to the generated correction profiles. In other words, based on the detection results of the leading registration sensors SN2L, SN2R and the detection results of the image sensors SN1L, SN1R, the controller 260 executes the correcting operation for the first correcting control, which includes the oblique movement correction and the lateral registration misalignment correction, as the correcting operation for the first time correcting control (S6). This correcting operation for the first correcting control is executed to be completed in the above first correcting section CS1 (see FIG. 2 and FIG. 3). By this, the oblique movement and the lateral misalignment of the sheet is roughly adjusted.

### (Second Correcting Control)

Next, the controller 260 proceeds to a series of processes of steps S7 through S10 as the second correcting control, which is a second time correcting control. First, the amount of the oblique movement of the sheet S is calculated based on the detection results input from the leading registration sensors SN3L, SN3R (S7). That is, when the leading end of the sheet S reaches both of the leading registration sensors SN3L, SN3R, the detecting operation for the second correcting control is started. In addition, similarly, the controller 260 calculates the position of the sheet S in the widthwise direction, in other words, the lateral misaligned position, based on the detection results input from the image sensors SN1L, SN1R (S8). Incidentally, the amount of the oblique movement and the lateral misaligned position of sheet S obtained here can be obtained by the same way as in the first correcting control.

Next, the controller 260 generates the oblique movement correction profiles as a second control amount to correct the oblique movement of the sheet S based on the amount of oblique movement of the sheet S determined as described above. In addition, the controller 260 generates the profiles for the lateral registration misalignment correction as the second control amount to correct the lateral misalignment of the sheet S based on the amount of the lateral misalignment of the sheet S determined as described above. And then the controller 260 generates the correction profiles composed of these oblique movement correction profiles and the profiles for the lateral registration misalignment correction (S9). That is, profile generating operation in the second correcting control is executed.

Next, the controller 260 controls the registration driving motors M1L, M1R and the steering motors M2L, M2R according to the generated correction profiles. In other words, based on the detection results of the leading registration sensors SN3L, SN3R and the image sensors SN1L, SN1R, the controller 260 executes the correcting operation of the second correcting control, which includes the oblique movement correction and the lateral registration misalignment correction, as the correcting operation for the second time correcting control (S10). This correcting operation of the second correcting control is executed to be completed in the above second correcting section CS2 (see FIG. 2 and FIG. 3). By this, the oblique movement and the lateral misalignment of the sheet, which has been roughly adjusted by the first correcting control, are further finely adjusted.

### (Image Forming Process)

Next, the controller 260 passes the sheet S to the printing belt 25 (see FIG. 2) after the completion of the second correcting control (S11). Next, the controller 260 performs the image formation onto the sheet S with the recording portion 230 (S12). The sheet S is then discharged to the discharging module 700 (see FIG. 1) (S13), and the controller 260 finishes the print job and finishes image forming operation for a single sheet.

Incidentally, in the case of the double-side printing, in which the image formation is performed on both sides (front surface and back surface) of the sheet S, the controller 260 reverses the sheet S with the reversing module 600 after the operation of the step S13 and conveys the sheet S again toward the registration roller pairs 240L, 240R. Then, the operations after the step S2 are performed in the same manner.

### Summary of the Embodiment 1

As described above, in the present Embodiment, the controller 260 executes the first correcting control with the registration unit 210, and after the first correcting control, the second correcting control is performed with the same registration unit 210. By this, it becomes no longer needed to dispose two or more mechanisms for performing the oblique movement correction and the lateral registration misalignment correction side-by-side in the conveyance direction, therefore it becomes possible to keep an apparatus from being increased in size. In addition, since the registration unit 210 performs the oblique movement correction (active registration operation) and the lateral registration misalignment correction (steering operation) while conveying the sheet, it is not necessary to stop the sheet once, therefore it becomes possible to keep improvement of productivity from being inhibited. Therefore, with the sheet conveying portion 200A in the present Embodiment, it becomes possible to keep an apparatus from being increased in size or keep improvement of productivity from being inhibited, while the first correcting control (rough adjustment) and the second correcting control (fine adjustment) can be executed.

In addition, in the present Embodiment, the leading registration sensors SN2L, SN2R, which detect the amount of the oblique movement of the sheet, and the leading registration sensors SN3L, SN3R, which are disposed downstream thereof in the conveyance direction X and detect the amount of the oblique movement of the sheet, are provided. In addition, the image sensors SN1L, SN1R which detect the position of the sheet in the widthwise direction are provided. By this, it becomes possible to execute the first correcting control according to the amount of the oblique movement of the sheet detected by the leading registration sensors SN2L, SN2R and the amount of the lateral misalignment detected by the image sensors SN1L, SN1R. In addition, it becomes possible to execute the second correcting control according to the amount of the oblique movement of the sheet detected by the leading registration sensors SN3L, SN3R and the amount of the lateral misalignment detected by the image sensors SN1L, SN1R.

In addition, in the present Embodiment, by performing the second correcting control before a trailing end of the sheet passes through the registration driving rollers 212L, 212R, it becomes possible to perform the fine adjustment of the oblique movement correction and the lateral registration misalignment correction of the sheet.

### Embodiment 2

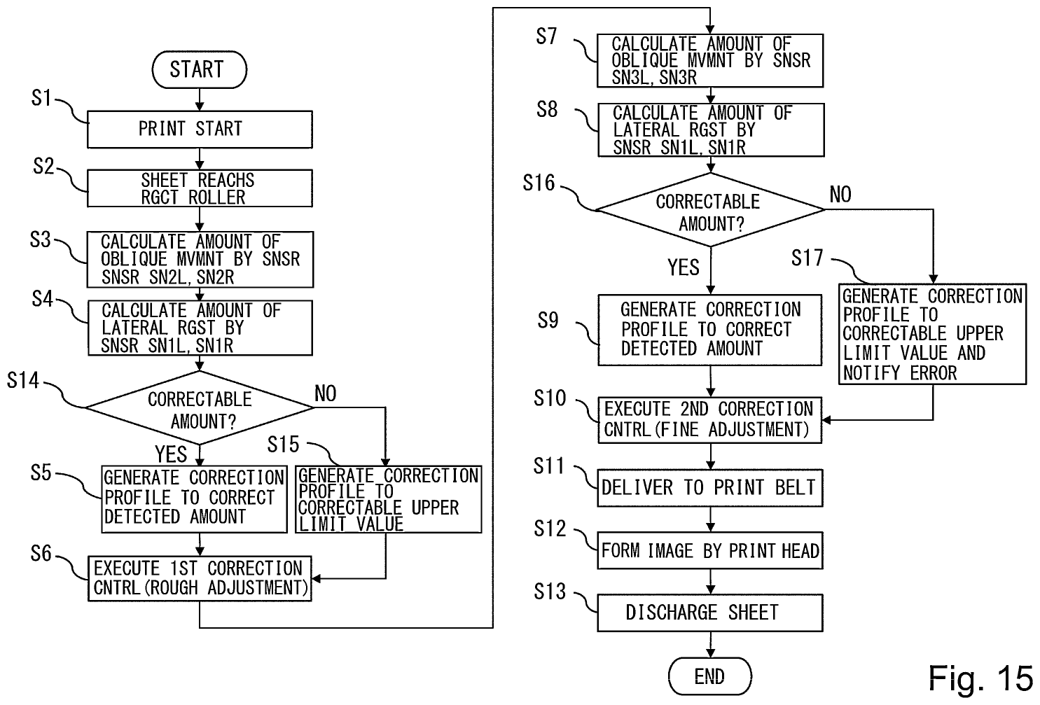

Next, an Embodiment 2, in which a part of the Embodiment 1 is changed, will be described using FIG. 15. FIG. 15 is a flow chart illustrating control of the printing module according to the Embodiment 2. Incidentally, in the description of the Embodiment 2, the same reference numerals are used for parts which are the same as the Embodiment 1, and the description thereof will be omitted.

In the Embodiment 2, compared to the Embodiment 1, it is determined whether or not the amount of the oblique movement or the amount of the lateral misalignment detected in the first correcting control or the second correcting control can be corrected by the registration unit 210. If it is not correctable with the registration unit 210, then correction is performed with an upper limit value which is correctable with the registration unit 210.

Specifically, as shown in FIG. 15, as in the Embodiment 1 (see FIG. 9), the first correcting control is started, the amount of the oblique movement of the sheet is detected by the leading registration sensors SN2L, SN2R (S3), and the amount of the lateral misalignment of the sheet is detected by the image sensors SN1L, SN1R (S4). Here, whether or not the detected amount of the oblique movement and the detected amount of the lateral misalignment are correctable with the registration unit 210 is determined (S14). If it is correctable (YES in S14), as in the Embodiment 1, the correction profiles are generated according to the detected amount of the oblique movement and the detected amount of the lateral misalignment (S5) and the first correcting control (rough adjustment) is performed (S6).

On the other hand, assuming that it is determined that the detected amount of the oblique movement is not correctable even if the oblique movement correction is performed by the registration unit 210, or that the detected amount of the lateral misalignment is not correctable even if the lateral registration misalignment correction is performed by the registration unit 210 (NO in S14). In other words, assuming that it is determined that at least one of the amount of the oblique movement and the amount of the lateral misalignment is not correctable with the first correcting control. In this case, the upper limit value, which is correctable with the registration unit 210, is set for the one or both of the amount of the oblique movement and the amount of the lateral misalignment, which are not correctable. Then, the correction profiles are generated by composing the oblique movement correction profiles and the profiles for the lateral registration misalignment correction, at least one of which is generated with the upper limit value (S15). Then, the first correcting control (rough adjustment) is executed by controlling the registration driving motors M1L, M1R and the steering motors M2L, M2R according to the correction profiles generated in this manner (S6).

In short, upon executing the first correcting control, assuming that at least one of the detected amount of the oblique movement of the sheet and the detected position of the sheet in the widthwise direction has a value which is not correctable even if the registration unit 210 is controlled by a correctable upper limit control amount. In this case, the correction profile as the first control amount is set to a correction profile, which is set by the upper limit value as the upper limit control amount.

Therefore, if the correction profile is generated with the upper limit value in this manner, the maximum of the oblique movement correction or the lateral registration misalignment correction is executed by the registration unit 210, however, an amount of the oblique movement or an amount of the lateral misalignment, which exceeds the upper limit value, is not corrected. However, in a state in which only the first correcting control is executed, it may be successfully corrected by the second correcting control which is performed next.

Then, the second correcting control is started, and the amount of the oblique movement of the sheet is detected by the leading registration sensors SN3L, SN3R (S7), and the amount of the lateral misalignment of the sheet is detected by the image sensors SN1L, SN1R (S8). Here, whether or not the detected amount of the oblique movement and the detected amount of the lateral misalignment are correctable with the registration unit 210 is determined (S16). If it is correctable (YES in S16), as in the Embodiment 1, the correction profiles are generated according to the detected amount of the oblique movement and the detected amount of the lateral misalignment (S9) and the second correcting control (fine adjustment) is performed (S10).

On the other hand, assuming that it is determined that at least one of the amount of the oblique movement and the amount of the lateral misalignment is not correctable with the second correcting control (NO in S16). In this case, the upper limit value, which is correctable with the registration unit 210, is set for the one or both of the amount of the oblique movement and the amount of the lateral misalignment, which are not correctable. Then, the correction profiles are generated by composing the oblique movement correction profiles and the profiles for the lateral registration misalignment correction, at least one of which is generated with the upper limit value (S17).

In short, upon performing the second correcting control, assuming that at least one of the detected amount of the oblique movement of the sheet and the detected position of the sheet in the widthwise direction has a value which is not correctable even if the registration unit 210 is controlled by the correctable upper limit control amount. In this case, the correction profile as the second control amount is set to a correction profile, which is set by the upper limit value as the upper limit control amount.

In addition, in this case, the image formed on the sheet is tilted or has the lateral misalignment, resulting in image defect, since it cannot be corrected correctly by the second correcting control. Therefore, the controller 260 treats the sheet as a sheet in which an error occurs. First, in step S17, the controller 260 outputs a signal to perform error notification to, for example, the operating portion 290 or the external computer, i.e., executes the error notification.

Then, while executing the error notification, the controller 260 executes the second correcting control by controlling the registration driving motors M1L, M1R and the steering motors M2L, M2R according to the correction profiles generated with the upper limit value in this manner (S10). By this, it becomes possible to correct the oblique movement and the lateral misalignment (i.e., posture) of the sheet as much as possible, thereby reducing occurrence of jams, etc. If no jam occurs, the inkjet recording system 1 can convey the sheet to, for example, the top tray 720 or the stacking portion 750 to complete the discharge without an emergency stop. In particular, by defining the top tray 720 as an error tray for discharging the sheet in which the error occurs, only the sheets with the image formation defect can be easily excluded. By controlling as described above, it becomes possible to reduce workload for jam processing, and to improve productivity without the emergency stop of the inkjet recording system 1.

Incidentally, in the first correcting control, in the case in which the correction profile is generated with the upper limit value (see S15), an example which is not treated as an error is described, however, it is not limited thereto but the sheet may be treated as a sheet in which an error occurs, as in step S17. In particular, in the second correcting control, since the sheet conveyance is in progress toward the recording portion 230, the oblique movement correction and the lateral registration misalignment correction are fine adjustments, and therefore the correctable upper limit value may be smaller compared to the rough adjustment as in the first correcting control. Therefore, if the first correcting control cannot correct the oblique movement or the lateral misalignment of the sheet, the second correcting control may not be able to correct either, therefore it may be configured to treat as an error at a stage of the first correcting control.

Incidentally, the other configurations, actions, and effects of the Embodiment 2 described above are the same as those of the Embodiment 1, therefore the description thereof will be omitted.

### Possibility for Other Embodiments

Incidentally, in the present Embodiment described above, an example in which the registration unit 210 performs the oblique movement correction upstream in the conveyance direction of the recording portion 230 as the image forming portion is described. However, it is not limited thereto but, for example, it may be configured that the oblique movement correction is performed upstream in the conveyance direction of an image reading portion which reads an image of a sheet, a hole punching portion which punches a hole in the sheet, or a folding portion which folds the sheet.

In short, the sheet conveying device which performs the oblique movement correction can be any device, or can be incorporated into any device.

In addition, in the Embodiment 1 and the Embodiment 2, examples in which the amount of the oblique movement and the position in the widthwise direction of the sheet are detected by the image sensors SN1L, SN1R, the leading registration sensors SN2L, SN2R, and the leading registration sensors SN3L, SN3R as the detecting portions are described. In addition, as other configurations for the detecting portion, configurations shown in FIG. 11B, FIG. 11C and FIG. 11D are described. However, it is not limited thereto but any configuration can be used as long as it is capable of detecting the amount of the oblique movement and the position in the widthwise direction of the sheet, for example, configurations capturing and analyzing an image, etc.

In addition, in the Embodiment 1 and the Embodiment 2, a configuration in which the image sensors SN1L, SN1R can detect the position of the sheet in the widthwise direction when the leading end of the sheet reaches the leading registration sensors SN3L, SN3R, no matter what size of the sheet as long as the size of the sheet can be conveyed, is described. However, it is not limited thereto but, for example, it may be configured that only the first correcting control is executed for the sheet having the smallest size which can be conveyed, while both the first correcting control and the second correcting control are executed for the other sizes. In other words, it may be configured in any manner as long as it is configured so that both the first correcting control and the second correcting control can be executed for at least one size.

In addition, in the Embodiment 1 and the Embodiment 2, examples in which the registration driving rollers 212L, 212R and the driving and whirling mechanisms 211L, 211R, which drive the registration driving rollers 212L, 212R, as what perform both the oblique movement correction and the lateral registration misalignment correction are described. However, it is not limited thereto but any configuration is acceptable as long as the configuration is capable of performing both the oblique movement correction and the lateral registration misalignment correction while conveying the sheet. In particular, it may be configured to include a mechanism capable of performing the oblique movement and the lateral registration misalignment correction upstream or downstream of the registration driving rollers 212L, 212R in the conveyance direction to perform the oblique movement correction three or more times in total or to perform the lateral registration misalignment correction three or more times in total.

The present invention may also be realized by a process in which a program realizing one or more functions of the Embodiments described above is supplied to the system or the apparatus via a network or a storage medium, and one or more processors in a computer of the system or the apparatus read out and execute the program. In addition, the present invention can also be realized by a circuit which realizes one or more functions (e.g., ASIC).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-131592 filed on Aug. 10, 2023, which is hereby incorporated by reference herein in its entirety.

What is claimed is:

1. A sheet conveying device comprising:
a correcting portion provided with a first correcting roller whirlable about a first axis in a crossing direction crossing a conveyance direction of a sheet and a widthwise direction perpendicular to the conveyance direction, and configured to correct a position of the sheet in the widthwise direction, and a second correcting roller disposed at a position different from the first correcting roller in the widthwise direction, whirlable about a second axis in the crossing direction, and configured to correct the position of the sheet in the widthwise direction;
a driving portion configured to whirlably drive the first correcting roller and the second correcting roller;
a side end detecting portion configured to detect a side end of the sheet in the widthwise direction of the sheet; and
a control portion configured to control the driving portion,
wherein based on a detection result of the side end detecting portion, the control portion executes a first correcting control in which the correcting portion corrects the position of the sheet in the widthwise direction and executes a second correcting control in which the correcting portion corrects the position of the sheet in the widthwise direction after the first correcting control.

2. A sheet conveying device according to claim 1, wherein the driving portion is provided with a first whirlable driving portion configured to whirlably drive the first correcting roller and a second whirlable driving portion configured to whirlably drive the second correcting roller, and
wherein the first correcting roller and the second correcting roller are independently whirlable.

3. A sheet conveying device according to claim 1, wherein the driving portion is provided with a first rotatable driving portion configured to rotatably drive the first correcting roller and a second rotatable driving portion configured to rotatably drive the second correcting roller, and
wherein the first correcting roller and the second correcting roller are independently rotatable.

4. A sheet conveying device according to claim 3, further comprising a first oblique movement detecting portion configured to detect oblique movement of the sheet, and
a second oblique movement detecting portion disposed downstream of the first oblique movement detecting portion in the conveyance direction and configured to detect the oblique movement of the sheet,
wherein the control portion corrects the oblique movement of the sheet by a rotational speed difference between the first correcting roller rotatably driven by the first rotatable driving portion and the second correcting roller rotatably driven by the second rotatable driving portion, and
wherein the control portion executes a third correcting control in which the correcting portion corrects the oblique movement of the sheet and the position of the sheet in the widthwise direction based on a detection result of the side end detecting portion and the first oblique movement detecting portion, and executes a fourth correcting control in which the correcting portion corrects the oblique movement of the sheet and the position of the sheet in the widthwise direction based on a detection result of the side end detecting portion and the second oblique movement detecting portion after the third correcting control.

5. A sheet conveying device according to claim 4, wherein when a leading end of the sheet of the minimum size conveyable by the sheet conveying device reaches the second oblique movement detecting portion, the side end detecting portion is disposed on a position so as to be capable of detecting the position of the sheet in the widthwise direction.

6. A sheet conveying device according to claim 1, wherein the control portion executes the second correcting control after the first correcting control and before a trailing end of the sheet passes through the first correcting roller and the second correcting roller.

7. A sheet conveying device according to claim 4, wherein the control portion sets a first control amount of the correcting portion when executing the third correcting control based on an amount of the oblique movement of the sheet and the position of the sheet in the widthwise direction detected by the first oblique movement detecting portion, the second oblique movement detecting portion and the side end detecting portion, and
wherein in executing the third correcting control in a case in which at least one of the amount of the oblique movement of the sheet and the position of the sheet in the widthwise direction detected by the first oblique movement detecting portion, the second oblique movement detecting portion and the side end detecting portion is a value which cannot be corrected by the correcting portion even when the correcting portion is controlled by an upper limit control amount by which the correcting portion is correctable, the control portion sets the first control amount to the upper limit control amount.

8. A sheet conveying device according to claim 7, wherein the control portion executes an error notification when the first control amount is set to the upper limit control amount.

9. A sheet conveying device according to claim 7, wherein the control portion sets a second control amount of the correcting portion when executing the fourth correcting control based on the amount of the oblique movement of the sheet and the position of sheet in the widthwise direction detected by the first oblique movement detecting portion, the second oblique movement detecting portion and the side end detecting portion, and
wherein in executing the fourth correcting control in a case in which at least one of the amount of the oblique movement of the sheet and the position of the sheet in the widthwise direction detected by the first oblique movement detecting portion, the second oblique movement detecting portion and the side end detecting portion is the value which cannot be corrected by the correcting portion even when the correcting portion is controlled by the upper limit control amount by which the correcting portion is correctable, the control portion sets the second control amount to the upper limit control amount.

10. A sheet conveying device according to claim 9, wherein the control portion executes an error notification when the second control amount is set to the upper limit control amount.

11. An image forming apparatus comprising:
a sheet conveying device according to claim 1; and
an image forming portion configured to form an image on a sheet conveyed by the sheet conveying device.
